(19) United States
(12) Patent Application Publication
(10) Pub. No.: US 2026/0177447 A1
(43) Pub. Date: Jun. 25, 2026

(54) Leak Detection Device and Related Methods

(71) Applicant: Android Industries LLC, Auburn Hills, MI (US)

(72) Inventors: James N. Martin, Perry, MI (US); Mark W. Erlenbeck, Grand Blanc, MI (US); Joshua James Hicks, Grand Blanc, MI (US); John E. Donnay, West Bloomfield, MI (US)

(21) Appl. No.: 19/422,563

(22) Filed: Dec. 17, 2025

Related U.S. Application Data
(60) Provisional application No. 63/736,007, filed on Dec. 19, 2024.

(51) Int. Cl. G01M 3/24; G08B 3/10; H04R 1/02; H04R 1/08

(52) U.S. Cl. CPC G01M 3/24; G08B 3/10; H04R 1/028; H04R 1/083; H04R 2499/13

(57) ABSTRACT

A leak detection device includes a housing, a receiver, a position sensor, and a microphone. The receiver is coupled to the housing and defines a cavity configured to receive a valve stem of a tire-wheel assembly. The position sensor is disposed within the cavity. The microphone is coupled to the housing and is in communication with the position sensor.

### CROSS-REFERENCE TO RELATED APPLICATIONS

This application claims the benefit of U.S. Provisional Application No. 63/736,007 filed Dec. 19, 2024, the entire disclosure of which is incorporated herein by reference.

### FIELD

The present disclosure relates to a leak detection device and more particularly to a leak detection device for detecting leaks in tire-wheel assemblies.

### BACKGROUND

Conventional leak detection devices may not be suitable for detecting slow leaks in valve stem leaks of tire-wheel assemblies. Slow leaks release air at low flow rates, which can make it difficult to identify the leak. Conventional leak detection devices typically detect leaks more easily when there is a noticeable rapid flow of air. While known leak detection devices have proven acceptable for their intended purpose, a continuous need for improvement remains in the art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a leak detection device. The leak detection device includes a housing, a receiver, a position sensor, and a microphone. The receiver is coupled to the housing and defines a cavity configured to receive a valve stem of a tire-wheel assembly. The position sensor is disposed within the cavity. The microphone is coupled to the housing and is in communication with the position sensor.

Another aspect of the disclosure provides a method for operating a leak detection device. The method includes receiving, by a receiver of the leak detection device, a valve stem of a tire-wheel assembly. The method includes detecting, by a position sensor of the leak detection device, that the valve stem is disposed in the receiver. The method includes, in response to the position sensor detecting that the valve stem is disposed in the receiver, automatically activating a microphone of the leak detection device. The method includes, in response to the microphone detecting sound coming from the valve stem, determining, by the leak detection device, that the valve stem has a leak.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example leak detection device in accordance with the principles of the present disclosure.

FIG. 2 is a bottom perspective view of a first portion of a housing of the leak detection device of FIG. 1.

FIG. 3 is a bottom perspective view of a second portion of the housing of the leak detection device of FIG. 1.

FIG. 4 is another bottom perspective view of the second portion of the housing in accordance with the principles of the present disclosure.

FIG. 5 is a top view of the second portion of the housing in accordance with the principles of the present disclosure.

FIG. 6 is a schematic view of an example leak detection device in accordance with the principles of the present disclosure.

FIGS. 7A and 7B are perspective view depicting example operations of the leak detection device of FIG. 1.

FIG. 8 is a flowchart depicting an example method for operating the leak detection device of FIG. 1.

In the drawings, reference numbers may be reused to identify similar and/or identical elements.

### DETAILED DESCRIPTION

### Introduction

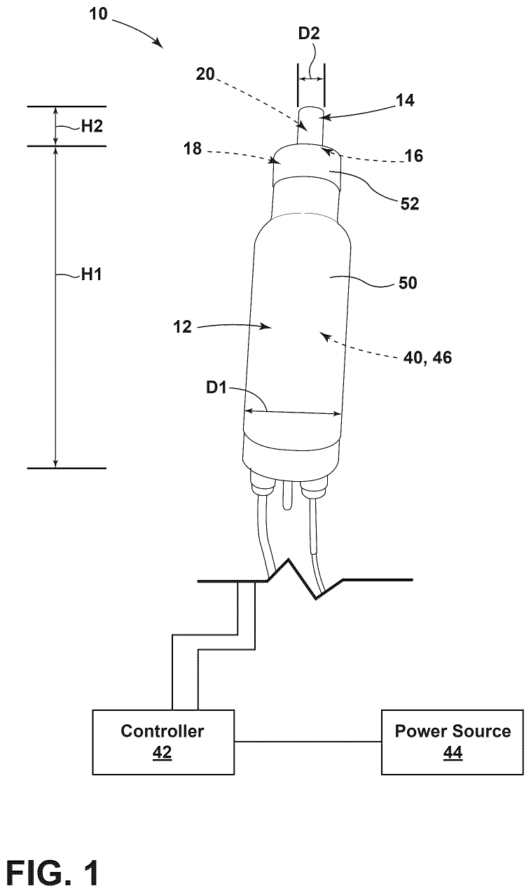

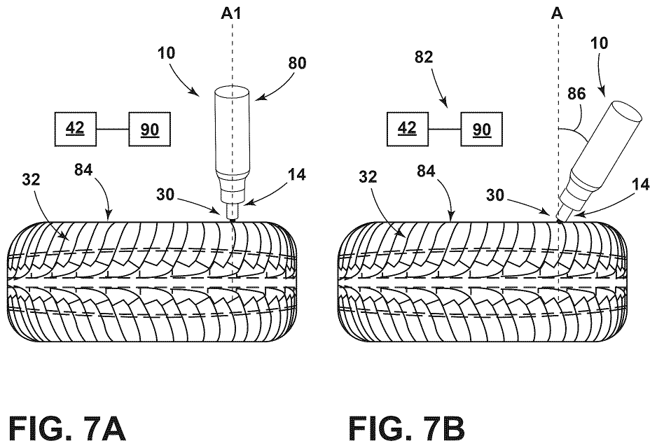

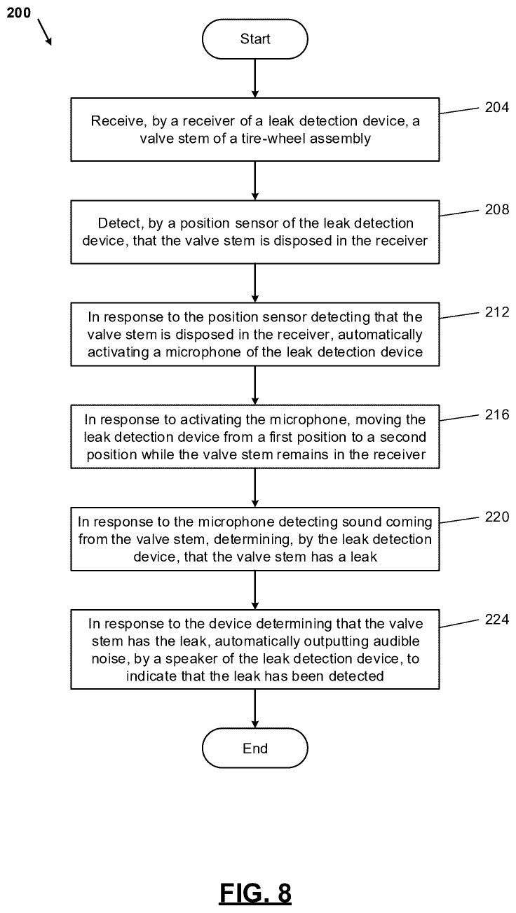

With reference to FIG. 1, an example leak detection device 10 is shown. In various implementations, the device 10 includes a housing 12, a receiver 14, a position sensor 16, and a microphone 18, among others. The receiver 14 may extend from the housing 12 and may define a cavity 20. The position sensor 16 may be disposed within the cavity 20 (see, e.g., FIG. 5). The microphone 18 may be coupled to the housing 12 and may be in communication with the position sensor 16. In various implementations, the receiver 14 receives a valve stem 30 of a tire-wheel assembly 32 (see, e.g., FIGS. 7A and 7B). As will be explained in more details below, the device 10 detects a leak (e.g., a slow leak, etc.) in the valve stem 30.

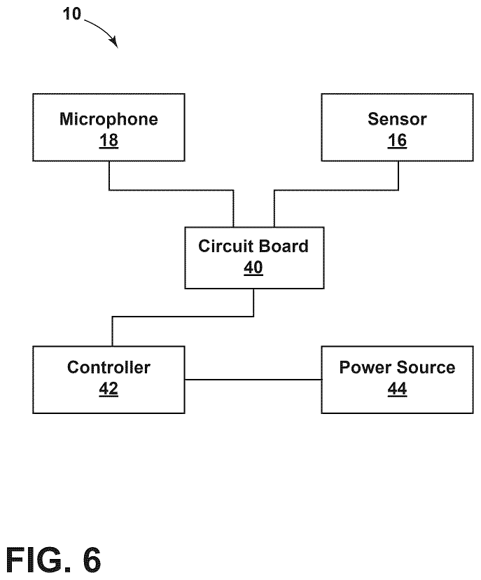

With reference to FIGS. 1 and 6, the device 10 may include a circuit board 40 (e.g., a printed circuit board (PCB)), a controller 42, and/or a power source 44, among others. In various implementations, the circuit board 40 is disposed within the housing 12 and includes various electrical components such as a speaker 46. The speaker 46 may output audible noise, for example, in response to the device 10 detecting a leak in the valve stem 30.

In various implementations, the circuit board 40 is electrically connected to the position sensor 16, the microphone 18, the controller 42, and/or the power source 44, among others. In various implementations, the controller 42 is electrically connected to the position sensor 16, the microphone 18, the circuit board 40, and/or the power source 44, among others. In various implementations, the power source 44 (e.g., one or more batteries, an alternative current (AC) power source, a direct current power (DC) power source, etc.) provides electrical energy required to operate the device 10.

In various implementations, the controller 42 includes an electronic controller and/or an electronic processor, such as a programmable microprocessor and/or microcontroller. The controller 42 may include an application specific integrated circuit (ASIC). The controller 42 may include a central processing unit (CPU), a memory (for example, a non-transitory computer-readable storage medium), and/or an input/output (I/O) interface. The controller 42 may perform various functions, including those described in greater detail herein, with appropriate programming instructions and/or code embodied in software, hardware, and/or other medium. The controller 42 may include a plurality of controllers. The controller 42 may be connected to a display, such as a touch screen.

### Housing

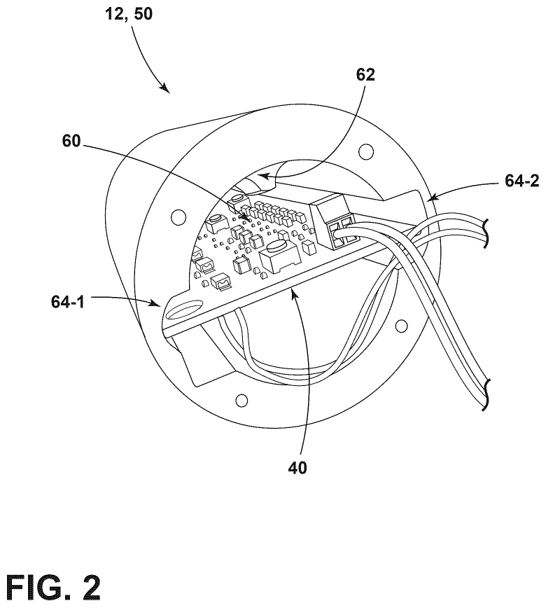

With continued reference to FIG. 1, in various implementations, the housing 12 includes a first portion 50 and a second portion 52 removably coupled to the first portion 50. Referring now to FIG. 2, in various implementations, the first portion 50 defines a cavity 60. The circuit board 40 may be disposed within the cavity 60. In various implementations, the first portion 50 includes an inner surface 62 that defines a first channel 64-1 and a second channel 64-2 opposite the first channel 64-1. Portions of the circuit board 40 may be disposed in the first channel 64-1 and the second channel 64-2.

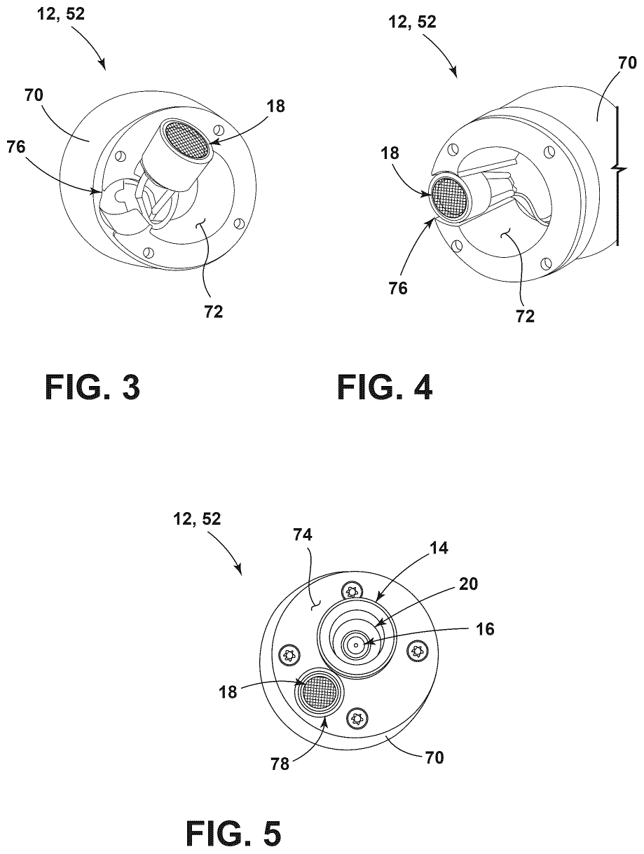

With reference to FIGS. 3-5, in various implementations, the second portion 52 includes a base 70. The receiver 14 may extend from the base 70. In various implementations, at least one of the base 70 or the receiver 14 defines a cylindrical-shaped configuration. In various implementations, the base 70 includes an inner surface 72 and an outer surface 74. The inner surface 72 may define a channel 76. The outer surface 74 may define an aperture 78 in communication with the channel 76. In various implementations, the microphone 18 is deposed in the channel 76 such that a portion of the microphone 18 is exposed via the aperture 78. The microphone 18 may be disposed adjacent to the position sensor 16.

Referring again to FIG. 1, in various implementations, the housing 12 defines a first diameter D1 and the receiver 14 defines a second diameter D2. The second diameter D2 may be less than the first diameter D1. In various implementations, the housing 12 defines a first height H1 and the receiver defines a second height H2. The second height H2 may be less than the first height H1.

### Sensor

In various implementations, the position sensor 16 detects the presence of a valve stem 30 within the cavity 20 of the receiver 14. The position sensor 16 may be a proximity sensor, an optical sensor, a magnetic sensor, a displacement sensor, an ultrasonic sensor, a laser displacement sensor, or a machinal limit switch, among others.

### Microphone

In various implementations, the microphone 18 detects sound (e.g., sound waves) coming from a valve stem 30, which indicates that the valve stem 30 has a leak (e.g., a slow leak, etc.). The sound coming from the valve stem 30 may be associated with a volume that is inaudible to a human (e.g., less than 0 dB and/or between 20 kHz to 200 kHz, etc.). In various implementations, the microphone 18 is an ultrasonic microphone, etc.

### Flowchart

FIG. 8 is a flowchart of an example method 200 for operating the leak detection device 10. The method 200 may be begin at 204. At 204, the receiver 14 receives a valve stem 30 of a tire-wheel assembly 32. In various implementations, the tire-wheel assembly 32 includes pressurized air. In various implementations, a user moves the device 10 so that the receiver 14 receives the valve stem 30. The method 200 may proceed to 208.

At 208, the position sensor 16 detects that the valve stem 30 is disposed in the receiver 14 (e.g., the cavity 20). The method 200 may proceed to 212. At 212, in response to the position sensor 16 detecting that the valve stem 30 is disposed in the receiver 14, the controller 42 automatically activates the microphone 18. The method 200 may proceed to 216.

At 216, in response to activating the microphone 18, the user may move the device 10 from a first position 80 (see, e.g., FIG. 7A) to a second position 82 (see, e.g., FIG. 7B), while the valve stem 30 remains in the receiver 14. In various implementations, moving the device 10 causes the valve stem 30 to move with the device, for example, from the first position 80 to the second position 82.

With reference to FIG. 7A, when the device 10 is in the first position 80, the device 10 and/or the valve stem 30 may extend orthogonally from a surface 84 of the tire-wheel assembly 32. The device 10 and/or the valve stem 30 may define an axis A1 that extends orthogonally from the surface 84 when in the first position 80. With reference to FIG. 7B, when the device 10 is in the second position 82, the device 10 and/or the valve stem 30 may extend at an angle 86 (e.g., 1 to 90 degrees) relative to the axis A1. In various implementations, moving the device 10 from the first position 80 to the second position 82 (e.g., pivoting the device relative to the axis A1) puts stress on the valve steam 30, which accentuates any existing leak in the valve steam 30.

With continued reference to FIGS. 7A and 7B, in some example configurations, the device 10 includes at least one motion sensor 90 (e.g., a gyroscope, an accelerometer, etc.) that detects movement of the device 10 and/or the valve stem 30. For example, the motion sensor 90 may be used to determine the angle 86 at which the device 10 and/or the valve stem 30 is disposed. The motion sensor 90 may be used to confirm that the user has moved the device 10, for example, from the first position 80 to the second position 82. The motion sensor 90 may be positioned adjacent to the tire-wheel assembly 32 and/or the device 10. The motion sensor 90 may be electrically connected to the controller 42. The method 200 may proceed to 220.

At 220, in response to the microphone 18 detecting sound coming from the valve stem 30, the device 10 (e.g., the controller 42) determines that the valve stem 30 has a leak. The method 200 may proceed to 224. At 224, in response to the device 10 determining that the valve stem 30 has the leak, automatically outputting audible noise, by the speaker 46, to indicate that the leak has been detected. Then, the method 200 may end.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP:
Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a leak detection device and related methods, as described above.
Clause 1: A leak detection device comprising: a housing; a receiver coupled to the housing and defining a cavity configured to receive a valve stem of a tire-wheel assembly; a position sensor disposed within the cavity; and a microphone coupled to the housing and in communication with the position sensor.
Clause 2: The leak detection device of clause 1, wherein the microphone is configured to detect a leak in the valve stem.
Clause 3: The leak detection device of clause 1 or 2, wherein the microphone is disposed adjacent to the position sensor.
Clause 4: The leak detection device of any of clauses 1 through 3, further comprising a circuit board, wherein: the housing defines an additional cavity, the circuit board is disposed in the additional cavity, and the circuit board is electrically connected to the position sensor and the microphone.
Clause 5: The leak detection device of clause 4, wherein: the housing includes an inner surface that defines a first channel and a second channel opposite the first channel, and portions of the circuit board are disposed in the first channel and the second channel.
Clause 6: The leak detection device of any of clauses 1 through 5, wherein: the housing includes a first portion and a second portion removably coupled to the first portion, the second portion includes a base, and the receiver extends from the base.
Clause 7: The leak detection device of clause 6, wherein: the base includes: an inner surface that defines a channel, and an outer surface that defines an aperture in communication with the channel, and the microphone is disposed in the channel such that a portion of the microphone is exposed via the aperture.
Clause 8: The leak detection device of clause 6, wherein at least one of the base or the receiver defines a cylindrical-shaped configuration.
Clause 9: The leak detection device of any of clauses 1 through 8, further comprising a controller electrically connected to the position sensor and the microphone, wherein the controller is configured to activate the microphone in response to the position sensor detecting a valve stem of a tire-wheel assembly disposed in the cavity of the receiver.
Clause 10: The leak detection device of clause 9, wherein, in response to the microphone detecting sound coming from the valve stem, outputting, by the leak detection device, a signal that indicates the valve stem includes a leak.
Clause 11: The leak detection device of any of clauses 1 through 10, further comprising a speaker disposed within the housing, wherein the speaker is configured to output audible noise in response to the leak detection device detecting a leak.
Clause 12: The leak detection device of any of clauses 1 through 11, wherein the microphone is an ultrasonic microphone.
Clause 13: The leak detection device of any of clauses 1 through 12, wherein the housing defines a first diameter and the receiver defines a second diameter that is less than the first diameter.
Clause 14: The leak detection device of any of clauses 1 through 13, wherein the housing defines a first height and the receiver defines a second height that is less than the first height.
Clause 15: A method for operating a leak detection device, the method comprising: detecting, by a position sensor of the leak detection device, that the valve stem is disposed in the receiver; in response to the position sensor detecting that the valve stem is disposed in the receiver, automatically activating a microphone of the leak detection device; and in response to the microphone detecting sound coming from the valve stem, determining, by the leak detection device, that the valve stem has a leak.
Clause 16: The method of clause 15, wherein the sound from the valve stem is associated with a volume less than zero decibels.
Clause 17: The method of clause 15 or 16, wherein the sound from the valve stem indicates that the tire-wheel assembly has a slow leak.
Clause 18: The method of any of clauses 15 through 17, further comprising, in response to activating the microphone, moving the leak detection device from a first position to a second position while the valve stem remains in the receiver.
Clause 19: The method of clause 18, wherein the second position is located at an angle relative to the first position.
Clause 20: The method of any of clauses 15 through 19, further comprising: in response to the leak detection device determining that the valve stem has the leak, automatically outputting a sound with a volume greater than zero decibels, by a speaker of the leak detection device, to indicate that the leak has been detected.

1. A leak detection device comprising:
a housing;
a receiver coupled to the housing and defining a cavity configured to receive a valve stem of a tire-wheel assembly;
a position sensor disposed within the cavity; and
a microphone coupled to the housing and in communication with the position sensor.

2. The leak detection device of claim 1 wherein the microphone is configured to detect a leak in the valve stem.

3. The leak detection device of claim 1 wherein the microphone is disposed adjacent to the position sensor.

4. The leak detection device of claim 1 further comprising a circuit board, wherein:
the housing defines an additional cavity,
the circuit board is disposed in the additional cavity, and
the circuit board is electrically connected to the position sensor and the microphone.

5. The leak detection device of claim 4 wherein:
the housing includes an inner surface that defines a first channel and a second channel opposite the first channel, and
portions of the circuit board are disposed in the first channel and the second channel.

6. The leak detection device of claim 1 wherein:
the housing includes a first portion and a second portion removably coupled to the first portion,
the second portion includes a base, and
the receiver extends from the base.

7. The leak detection device of claim 6 wherein:
the base includes:
an inner surface that defines a channel, and
an outer surface that defines an aperture in communication with the channel, and
the microphone is disposed in the channel such that a portion of the microphone is exposed via the aperture.

8. The leak detection device of claim 6 wherein at least one of the base or the receiver defines a cylindrical-shaped configuration.

9. The leak detection device of claim 1 further comprising a controller electrically connected to the position sensor and the microphone,
wherein the controller is configured to activate the microphone in response to the position sensor detecting a valve stem of a tire-wheel assembly disposed in the cavity of the receiver.

10. The leak detection device of claim 9 wherein, in response to the microphone detecting sound coming from the valve stem, outputting, by the leak detection device, a signal that indicates the valve stem includes a leak.

11. The leak detection device of claim 1 further comprising a speaker disposed within the housing,
wherein the speaker is configured to output audible noise in response to the leak detection device detecting a leak.

12. The leak detection device of claim 1 wherein the microphone is an ultrasonic microphone.

13. The leak detection device of claim 1 wherein the housing defines a first diameter and the receiver defines a second diameter that is less than the first diameter.

14. The leak detection device of claim 1 wherein the housing defines a first height and the receiver defines a second height that is less than the first height.

15. A method for operating a leak detection device, the method comprising:
detecting, by a position sensor of the leak detection device, that a valve stem is disposed in a receiver;
in response to the position sensor detecting that the valve stem is disposed in the receiver, automatically activating a microphone of the leak detection device; and
in response to the microphone detecting sound coming from the valve stem, determining, by the leak detection device, that the valve stem has a leak.

16. The method of claim 15 wherein the sound from the valve stem is below zero decibels.

17. The method of claim 15 wherein the sound from the valve stem indicates that the tire-wheel assembly has a slow leak.

18. The method of claim 15 further comprising, in response to activating the microphone, moving the leak detection device from a first position to a second position while the valve stem remains in the receiver.

19. The method of claim 18 wherein the second position is located at an angle relative to the first position.

20. The method of claim 15 further comprising:
in response to the leak detection device determining that the valve stem has the leak, automatically outputting a sound greater than zero decibels, by a speaker of the leak detection device, to indicate that the leak has been detected.
